(19) United States
(12) Patent Application Publication
(10) Pub. No.: US 2015/0131092 A1
(43) Pub. Date: May 14, 2015

(54) OPTICAL DEVICE AND DETECTION APPARATUS

(71) Applicant: SEIKO EPSON CORPORATION, Tokyo (JP)

(72) Inventors: Yusuke Sakagami, Shiojiri (JP); Kohei Yamada, Suwa (JP); Akiko Yamada, Suwa (JP)

(21) Appl. No.: 14/398,078

(22) PCT Filed: Apr. 23, 2013
(86) PCT No.: PCT/JP2013/002722

§ 371 Date: Oct. 30, 2014

(30) Foreign Application Priority Data
May 1, 2012 (JP) 2012-104462

(51) Int. Cl. G01N 21/65

(52) U.S. Cl. CPC G01N 21/658; G01N 2201/06113
USPC 356/301; 362/317

(57) ABSTRACT

An optical device and a detection apparatus, with which a measurement sample over a wide concentration range can be detected even if the concentration of a measurement target is relatively low are to be provided.

An optical device emits a light for detecting and/or identifying a measurement sample when a light from a light source is incident thereon. This optical device includes multiple metal nanostructures formed on a dielectric body, a first organic molecular film which is formed on the dielectric body between two adjacent metal nanostructures among the multiple metal nanostructures, and a second organic molecular film which is different from the first organic molecular film and is formed on the multiple metal nanostructures. The first organic molecular film and the second organic molecular film attach (capture) a measurement sample 1.

### TECHNICAL FIELD

The present invention relates to an optical device, a detection apparatus, etc.

### BACKGROUND ART

Recently, a demand for a sensor chip to be used for medical diagnoses, tests for foods and beverages, etc. has increased, and the development of a highly sensitive and small-sized sensor chip has been demanded. In order to meet such a demand, a variety of types of sensor chips such as a sensor chip using an electrochemical process have been studied. Among these, sensor chips using a spectroscopic analysis utilizing surface plasmon resonance (SPR), particularly, surface-enhanced Raman scattering (SERS) have drawn increasing attention for the reasons that integration is possible, the cost is low, measurement can be performed in any environment, and so on.

Here, the “surface plasmon” refers to an oscillation mode of an electron wave that is coupled to a light depending on boundary conditions specific to a surface. As a method for exciting surface plasmons, there are a method in which a diffraction grating is imprinted on a metal surface to couple a light to plasmons and a method in which an evanescent wave is used. For example, as a sensor utilizing SPR, a sensor configured to include a total reflection prism and a metal film which comes into contact with a target substance formed on the surface of the prism is known. According to such a configuration, whether or not a target substance is adsorbed, for example, whether or not an antigen is adsorbed in an antigen-antibody reaction, or the like is detected.

However, while propagating surface plasmons exist on a metal surface, localized surface plasmons exist on metal nanostructures. It is known that when the localized surface plasmons, i.e., the surface plasmons localized on the metal nanostructures on the surface are excited, a significantly enhanced electric field is induced.

It is also known that when an enhanced electric field formed by localized surface plasmon resonance (LSPR) using metal nanostructures is irradiated with a Raman scattered light, the Raman scattered light is enhanced by surface-enhanced Raman scattering phenomenon, and therefore, a sensor (detection apparatus) with high sensitivity has been proposed. By using this principle, it becomes possible to detect a small amount of various substances.

An enhanced electric field is strong around metal nanostructures, particularly in a gap between adjacent metal nanostructures, and therefore, it is necessary to retain a target molecule in a fluid sample in the gap between metal nanostructures. For example, in JP-A-2009-222401 and P. Freunscht et al., “Surface-enhanced Raman spectroscopy of trans-stilbene adsorbed on platinum or self-assembled monolayer-modified silver film over nanosphere surfaces”, Chemical Physics Letters, 281 (1997), 372-378, on a metal surface of a sensor chip, a self-assembled monolayer (SAM) is formed. Further, JP-A-2009-216483 has proposed that a sensor chip is formed by mixing different types of SAM films.

### SUMMARY OF INVENTION

### Technical Problem

This type of detection apparatus is excellent in that a measurement sample at an extremely low concentration can be detected, however, it is conceivable that the range of the concentration to be detected is wide depending on the measurement sample. However, even if the concentration of a measurement target is relatively low, there is a limit when a measurement sample over a wide concentration range is detected, and the SERS signal level is saturated.

In light of this, an object of several aspects of the invention is to provide an optical device and a detection apparatus, with which a measurement sample over a wide concentration range can be detected even if the concentration of a measurement target is relatively low.

### Solution to Problem

(1) One aspect of the invention relates to an optical device, which emits a light for detecting and/or identifying a measurement sample when an excitation light is incident thereon, wherein the optical device includes:

multiple metal nanostructures formed on a dielectric body;

a first organic molecular film, which is formed on the dielectric body between two adjacent metal nanostructures among the multiple metal nanostructures; and

a second organic molecular film, which is different from the first organic molecular film and is formed on the multiple metal nanostructures, and

the first organic molecular film and the second organic molecular film attach (capture) the measurement sample.

In this aspect of the invention, an enhanced electric field is formed between the metal nanostructures to create a hotspot. On the other hand, an enhanced electric field in a region facing the metal nanostructures is not as strong as the enhanced electric field between the metal nanostructures. Therefore, by focusing on the fact that the enhanced electric field varies between in the region of the metal nanostructures and in the region between the metal nanostructures, we intended to perform detection over a wide concentration range from a low concentration to a high concentration.

Here, if the desorption activation energy for keeping the measurement sample adsorbed on the metal nanostructures is low, a thermal energy of around room temperature exceeds the desorption activation energy, and therefore, the measurement sample is desorbed. By the first and second organic molecular films, a higher desorption activation energy than the desorption activation energy of only the metal nanostructures is ensured, and therefore, the desorption of the measurement sample can be prevented. Accordingly, the detection signal level can be increased.

Further, the magnitude of the desorption activation energy ensured by the first and second organic molecular films varies therebetween, and therefore, by selecting the first and second organic molecular films, the detection sensitivity over a concentration range from a low concentration to a high concentration can be appropriately adjusted.

For example, the region between the metal nanostructures where the first organic molecular film is formed is a hotspot where the enhanced electric field is strong, and even in the case of a measurement sample at a low concentration, detection with high sensitivity can be achieved. On the other hand, in the region of the metal nanostructures where the second organic molecular film is formed, the enhanced electric field is relatively weak, however, as long as the measurement sample is at a high concentration, a signal level based on the detected light reflecting the measurement sample is ensured. Therefore, the region where the first organic molecular film is formed can serve as a first detection region where the measurement sample at a low concentration is detected, and the region where the second organic molecular film is formed can serve as a second detection region where the measurement sample at a high concentration is detected. In this manner, the concentration range of the measurement sample capable of being detected by one detection apparatus is expanded. Further, by selecting the first and second organic molecular films, the measurement sample in a concentration range in which the signal level based on the light to be detected in the first detection region where the first organic molecular film is formed is saturated can be detected in the second detection region where the second organic molecular film is formed.

(2) According to the aspect of the invention, the first organic molecular film may have a silane coupling agent, a silanol group (—Si—OH), a titanium coupling agent, or a titanol group (—Ti—OH).

The organic molecular film having such a group is easily adsorbed on the dielectric body of SiO₂ or the like, and therefore is preferred as the first organic molecular film. Incidentally, the silane coupling agent or the titanium coupling agent is produced by hydrolysis or the like of a silanol group (—Si—OH) or a titanol group (—Ti—OH), which binds to an OH group of the dielectric body.

(3) According to the aspect of the invention, the second organic molecular film may have a thiol group (—SH), a disulfide group (—S—S—), or a carboxyl group (—COOH).

The organic molecular film having such a group is easily adsorbed on a metal, and therefore is preferred as the second organic molecular film.

(4) According to the aspect of the invention, the molecular length of the first organic molecular film may be shorter than that of the second organic molecular film. The molecular length of the organic molecular film is preferably suitable for the magnitude of the enhanced electric field in the region where the organic molecular film is formed. In the region of the metal nanostructures, the enhanced electric field is formed in a wide range, and therefore, the second organic molecular film having a long molecular length is selected, and in the region between the metal nanostructures, the enhanced electric field is formed in a narrow range, and therefore, the first organic molecular film having a short molecular length can be selected.

(5) Another aspect of the invention relates to a detection apparatus including:

a light source;

the optical device according to any one of (1) to (4), on which a light from the light source is made incident; and

a light detector which detects a light emitted from the optical device.

This detection apparatus can detect a measurement sample with high sensitivity over a concentration range from a low concentration to a high concentration.

### BRIEF DESCRIPTION OF DRAWINGS

FIG. 1 is a view showing a basic structure of an optical device according to a first embodiment of the invention.

FIGS. 2(A) to 2(D) are views for explaining the detection principle of a surface-enhanced Raman scattered light.

FIG. 3 is a view showing an intermediate substrate having a second organic molecular film formed on the basic structure in FIG. 1.

FIG. 4 is a view showing the optical device according to the first embodiment of the invention having a first organic molecular film formed on the intermediate substrate in FIG. 3.

FIG. 5 is a view showing the results of an SERS signal obtained when exposing to various saturated vapor gases and the results of measuring the adsorption amounts of the various saturated vapor gases.

FIG. 6 is a view showing the ratio of a desorption residual amount after switching to exposure to air when the value obtained by the exposure to each of the saturated vapor gases is taken as 1.

FIG. 7 is a view showing the relationship between adsorption and a desorption activation energy.

FIG. 8 is a view showing that a change in mass of molecules adsorbed on the surface of QCM is measured as a change in frequency.

FIG. 9 is a view showing a desorption activation energy for each of various gases measured by changing the presence or absence of the organic molecular film and the type of the organic molecular film.

FIG. 10 is a view showing the detection in a wide range over the concentration ranges 1 and 2.

FIG. 11 is a view showing a formation example of an organic molecular film by a liquid phase method.

FIG. 12 is a view showing the limit of a region where an organic molecular film is formed by a liquid phase method.

FIG. 13 is a view showing a formation example of an organic molecular film by a gas phase method.

FIG. 14 is a view showing another formation example of an organic molecular film by a gas phase method.

FIG. 15 is a view showing an SERS chip used for forming first and second SAMs.

FIG. 16 is a view showing the FT-IR spectrum of an SERS chip before and after forming a first SAM film 18.

FIG. 17 is a view showing the SERS spectrum measured using the SERS chip before and after forming the first SAM film 18.

FIG. 18 is a view showing the overall structure of a detection apparatus according to a fourth embodiment of the invention.

FIG. 19 is a block diagram of a control system of the detection apparatus shown in FIG. 18.

FIG. 20 is a view showing a light source of the detection apparatus shown in FIG. 18.

FIG. 21 is a view showing two resonators and a distortion adding section provided for the light source shown in FIG. 18.

FIG. 22 is a view showing a modification of the basic structure of the optical device shown in FIG. 1.

FIG. 23 is a view showing an optical device in which as the metal nanostructures, Ag islands are formed.

### DESCRIPTION OF EMBODIMENTS

Hereinafter, preferred embodiments of the invention will be described in detail. The embodiments described below do not unduly limit the contents of the invention described in the claims, and all of the structures described in the embodiments are not indispensable for the solving means of the invention.

### 1. First Embodiment

### 1.1. Basic Structure of Optical Device

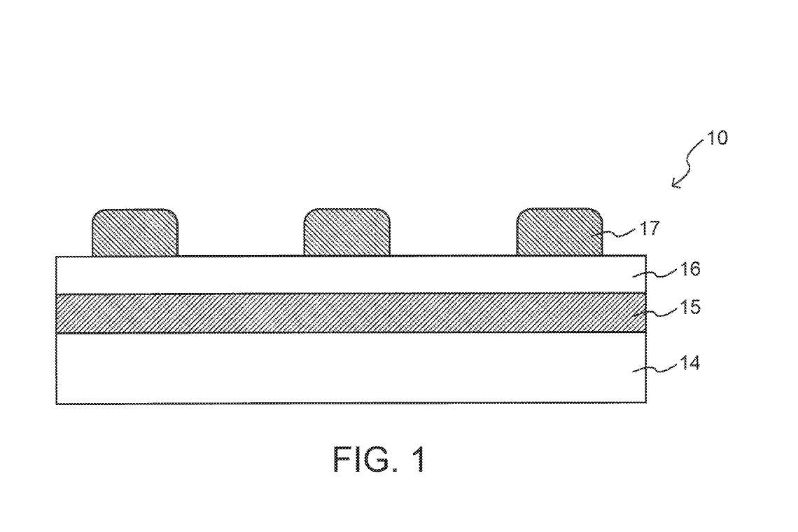

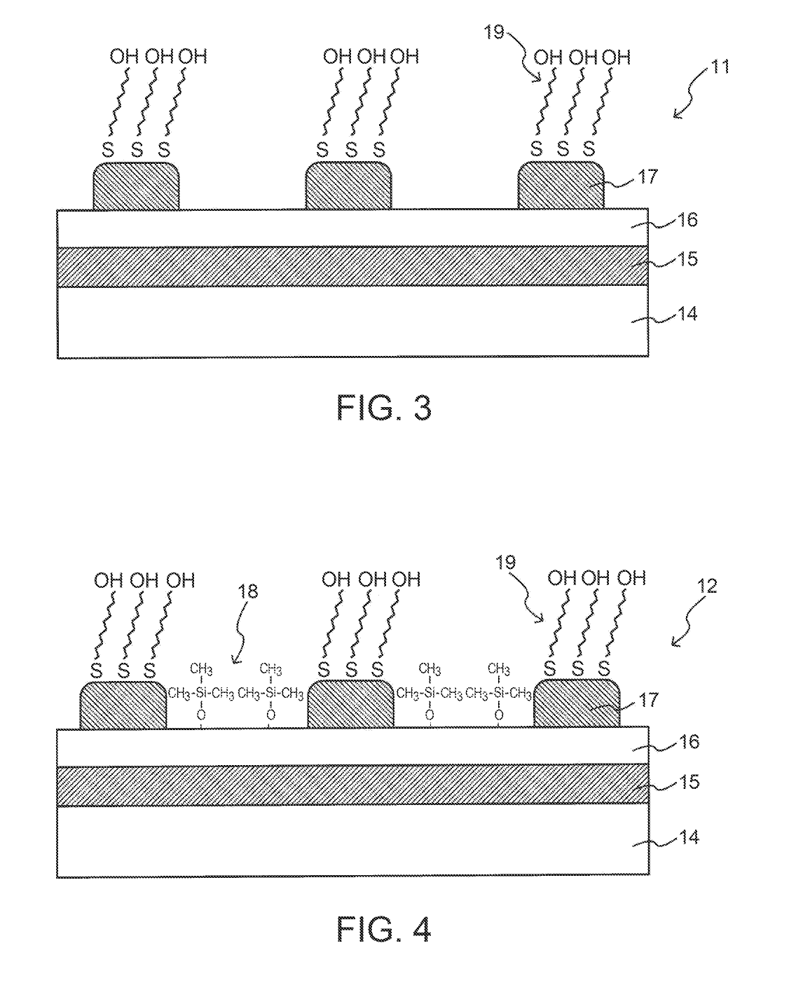

FIG. 1 shows a basic substrate 10 which is a basic structure of an optical device 12 according to a first embodiment. The optical device 12 of the first embodiment includes the basic substrate 10 shown in FIG. 1 as a base, and is completed by, for example, forming first and second organic molecular films 18 and 19 on the basic substrate 10 as shown in FIG. 4 through an intermediate substrate 11 having the second organic molecular film 19 formed thereon shown in FIG. 3. First, the basic substrate 10 will be described.

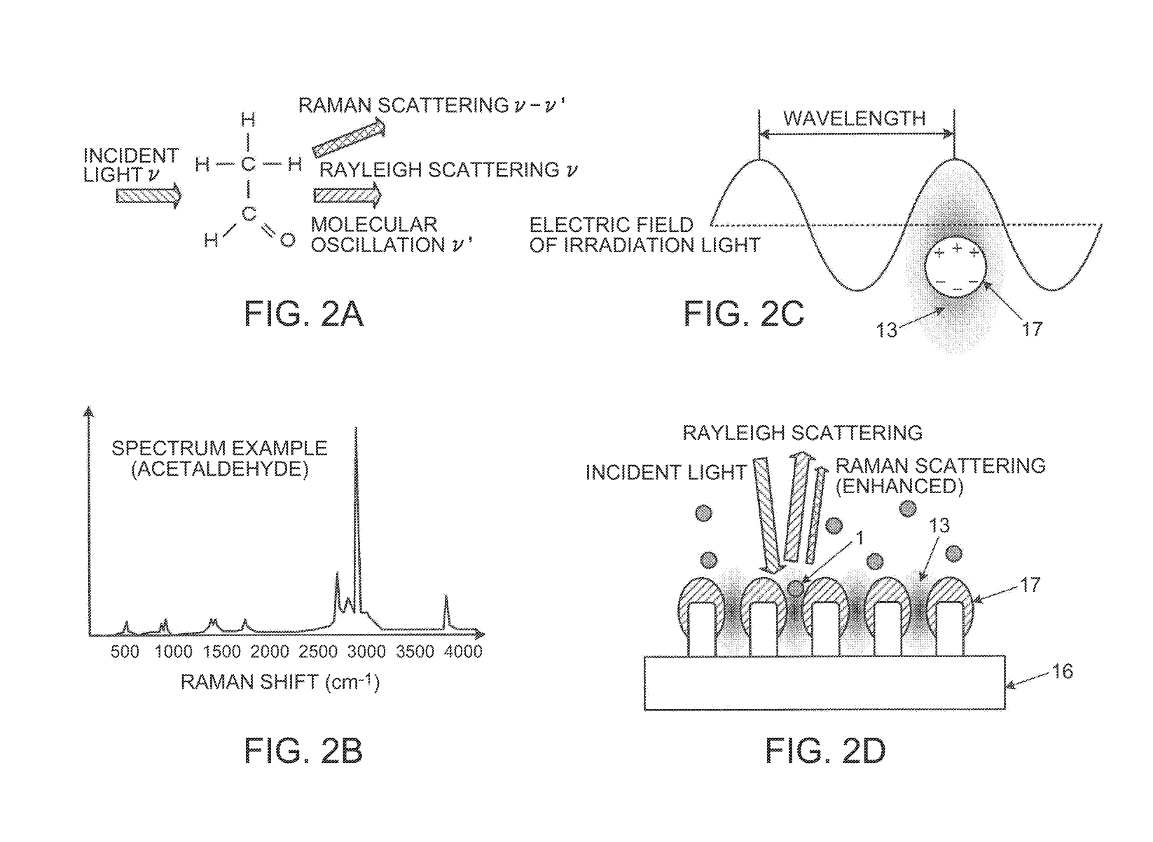

In the optical device 12 shown in FIG. 4, the basic substrate 10 shown in FIG. 1 includes a base plate 14, a metal (conductive) film 15 formed on the base plate 14, a dielectric body 16 formed on the metal film 15, and metal nanostructures 17 formed on the dielectric body 16. The metal nanostructures 17 may be arranged one-dimensionally or two-dimensionally. Further, the metal nanostructures 17 are metal nanoparticles having a nanometer-order size smaller than the wavelength of an incident light, and have a size of 1 to 1000 nm. As the metal nanostructures 17, for example, gold (Au), silver (Ag), copper (Cu), aluminum (Al), palladium (Pd), nickel (Ni), platinum (Pt), molybdenum (Mo), chromium (Cr), or an alloy thereof or a composite thereof is used. The metal nanostructures 17 may be formed so as to cover the convex portions of the dielectric body 16 (see FIG. 2(D)).

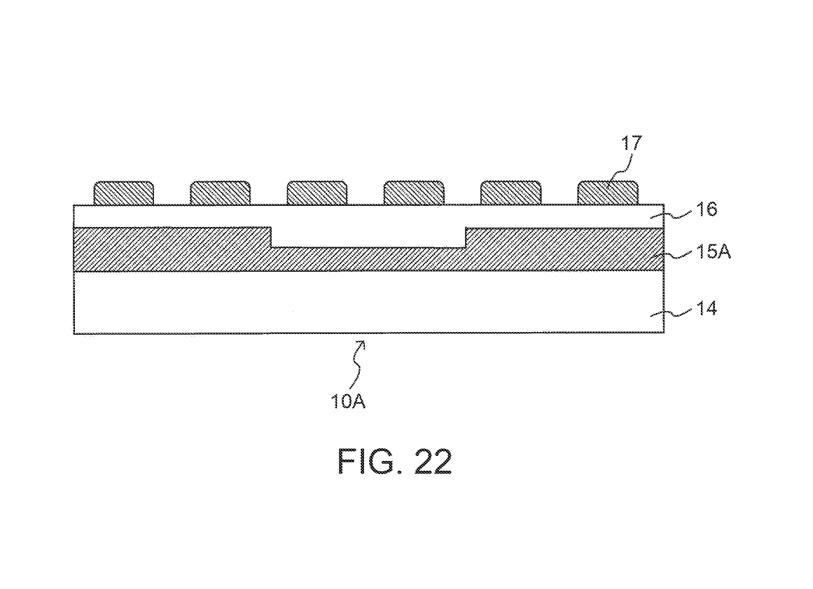

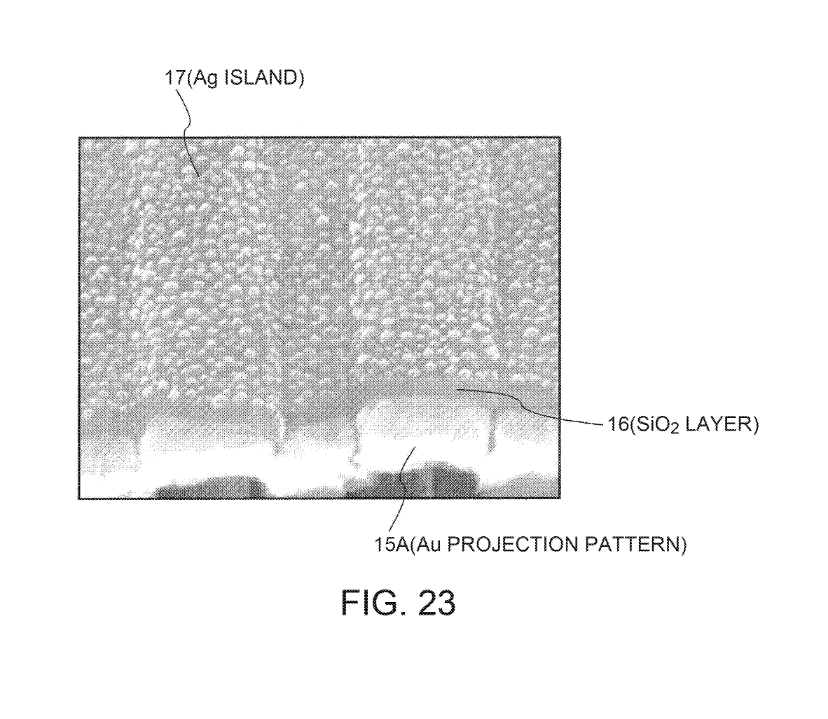

The metal film 15 is formed as an enhanced structure of propagating plasmons, and a smooth film (FIG. 1), a metallic diffraction grating with periodic projections (see FIGS. 22 and 23 below), or the like is suitable. In FIG. 1, an example in which the metal film 15 of gold (Au) is formed by a vacuum vapor deposition method or a sputtering method is shown. The thickness of the Au film is desirably from about 10 nm to several tens of nanometers. As the type of the metal, gold (Au), silver (Ag), copper (Cu), aluminum (Al), platinum (Pt), nickel (Ni), palladium (Pd), tungsten (W), rhodium (Rh), ruthenium (Ru), or the like is suitable.

As he dielectric body 16, SiO₂, Al₂O₃, TiO₂, or the like is suitable, and the thickness thereof is desirably from about 10 nm to 500 nm.

### 1.2. Light Detection Principle

With reference to FIGS. 2(A) to 2(D), as one example of the detection principle of a light reflecting a fluid sample, the detection principle of a Raman scattered light will be described. As shown in FIG. 2(A), a sample (sample molecule) 1 which is a detection target to be adsorbed on the optical device 12 is irradiated with an incident light (frequency: V). In general, most of the incident light is scattered as a Rayleigh scattered light, and the frequency V or the wavelength of the Rayleigh scattered light does not change from that of the incident light. Part of the incident light is scattered as a Raman scattered light, and the frequency (ν-ν′ and ν+ν′) or the wavelength of the Raman scattered light reflects the frequency ν′ (molecular oscillation) of the sample molecule 1. That is, the Raman scattered light is a light reflecting the sample molecule 1 to be detected. Part of the incident light oscillates the sample molecule 1 and loses energy, but the oscillation energy of the sample molecule 1 may sometimes be added to the oscillation energy or the light energy of the Raman scattered light. Such shift in frequency (ν′) is called Raman shift.

FIG. 2(B) shows an example of acetaldehyde as a fingerprint spectrum specific to a target molecule. By this fingerprint spectrum, the detected substance can be identified as acetaldehyde. However, the intensity of the Raman scattered light is very low, and therefore, it was difficult to detect a substance which is present only in a small amount.

As shown in FIG. 2(D), in a region where the incident light is incident, an enhanced electric field 13 is formed in a gap between the adjacent metal nanostructures 17. In particular, as shown in FIG. 2(C), when the metal nanostructures 17 smaller than the wavelength λ of an incident light is irradiated with the incident light, the electric field of the incident light acts on free electrons present on the surface of the metal nanostructures 17 to cause resonance. Due to this, electric dipoles are excited in the metal nanostructures 17 by the free electrons, and a stronger enhanced electric field 13 than the electric field of the incident light is formed. This is also referred to as localized surface plasmon resonance (LSPR). This phenomenon is a phenomenon specific to a metal particle having a convex portion with a size of 1 to 100 nm which is smaller than the wavelength of the incident light.

In this embodiment, localized surface plasmons and propagating surface plasmons can be used in combination. The propagating surface plasmons can be formed by a propagating structure formed on the metal film 15. For example, as disclosed in Japanese Patent Application No. 2011-139526 applied by the present applicant, if the metal film 15 has a lattice plane with periodic projections, when a light is incident on the periodic projections of the lattice, surface plasmons are generated. When the polarization direction of the incident light is orthogonalized to the groove direction of the lattice, the oscillation of electromagnetic waves is excited as the oscillation of free electrons in the metal lattice. This oscillation of electromagnetic waves has an influence on the oscillation of free electrons, and therefore, a surface plasmon polariton which is a system in which both oscillations are combined is formed. Even if the metal film 15 is smooth, propagating surface plasmons are generated. This surface plasmon polariton propagates along the interface between the metal film. 15 and the dielectric body 16 to further enhance the enhanced electric field 13.

### 1.3. Optical Device Having First and Second Organic Molecular Films

In this embodiment, the optical device 12, which is a completed product, has a first organic molecular film 18 and a second organic molecular film 19 on its surface as shown in FIG. 4. The first and second organic molecular films 18 and 19 are adsorption films capturing a molecule which is a fluid sample, and are formed from, for example, a self-assembled monolayer (SAM). The first and second organic molecular films 18 and 19 are formed from SAM films different from each other. The first organic molecular film 18 is formed on the dielectric body 16 between two adjacent metal nanostructures 17. The second organic molecular film 19 is formed on the metal nanostructures 17. For production reasons described below, the second organic molecular film 19 is first formed as shown in FIG. 3, and then, the first organic molecular film 18 is formed as shown in FIG. 4. However, the order is not limited to this order.

In order to detect the SERS signal having been described with reference to FIGS. 2(A) to 2(D), a target molecule needs to be adsorbed on the surface of the optical device 12. It has been reported that metals considered to have a high plasmon resonance effect among metals are silver (Ag), gold (Au), platinum (Pt), and the like, however, not all target molecules show excellent adsorbability on these metals. Even if a target molecule is adsorbed on a metal once, when the desorption activation energy Ed is small, the molecule is immediately desorbed by a thermal energy of around room temperature, and therefore, the SERS signal cannot be obtained.

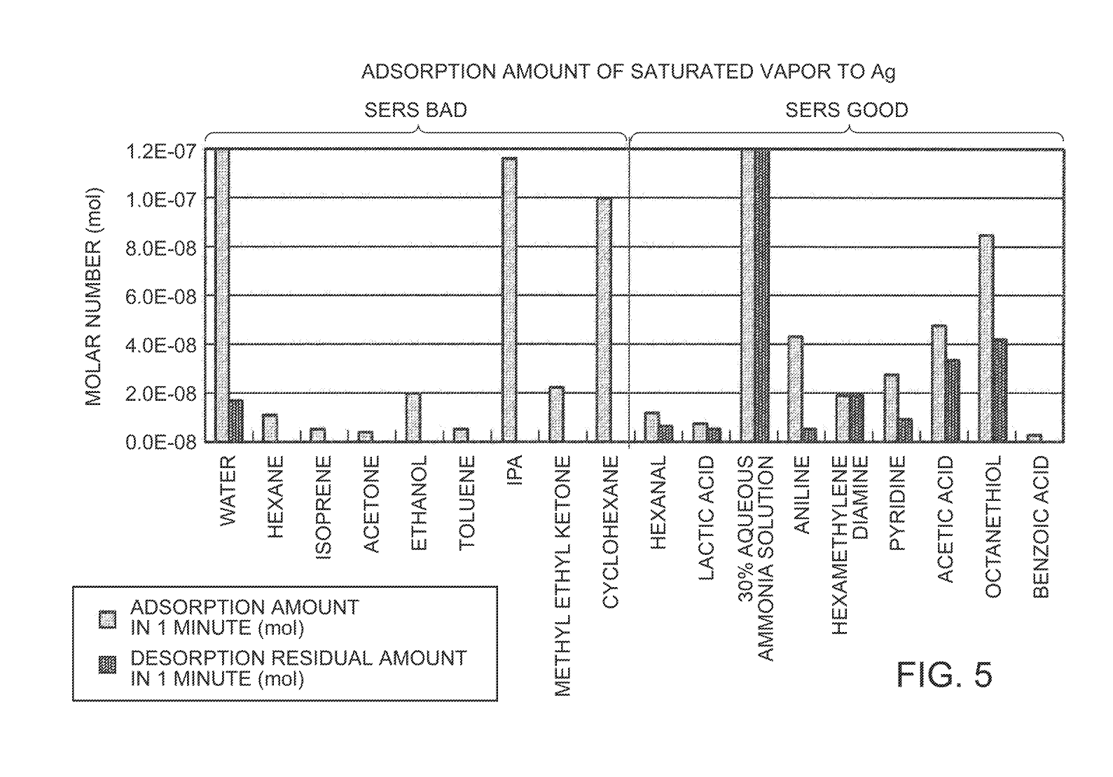

FIG. 5 shows the results when exposing a substrate having Ag nanostructures as the metal nanostructures formed on a quartz glass base plate to any of various saturated vapor gases. Except for water, in the case of gases whose residual amount after switching to exposure to air is large (gases shown in the right of FIG. 5), the SERS signal is detected. FIG. 5 also shows the results obtained by exposing a thickness-shear mode quartz crystal resonator (QCM) to any of various saturated vapor gases in the same manner and determining the adsorption amount based on a change in frequency of the quartz crystal resonator. In FIG. 5, the amount adsorbed by the exposure to the saturated vapor gas for 1 minute and the desorption residual amount remaining 1 minute after switching to the exposure to air from the exposure to the saturated vapor gas are shown by a bar graph, respectively.

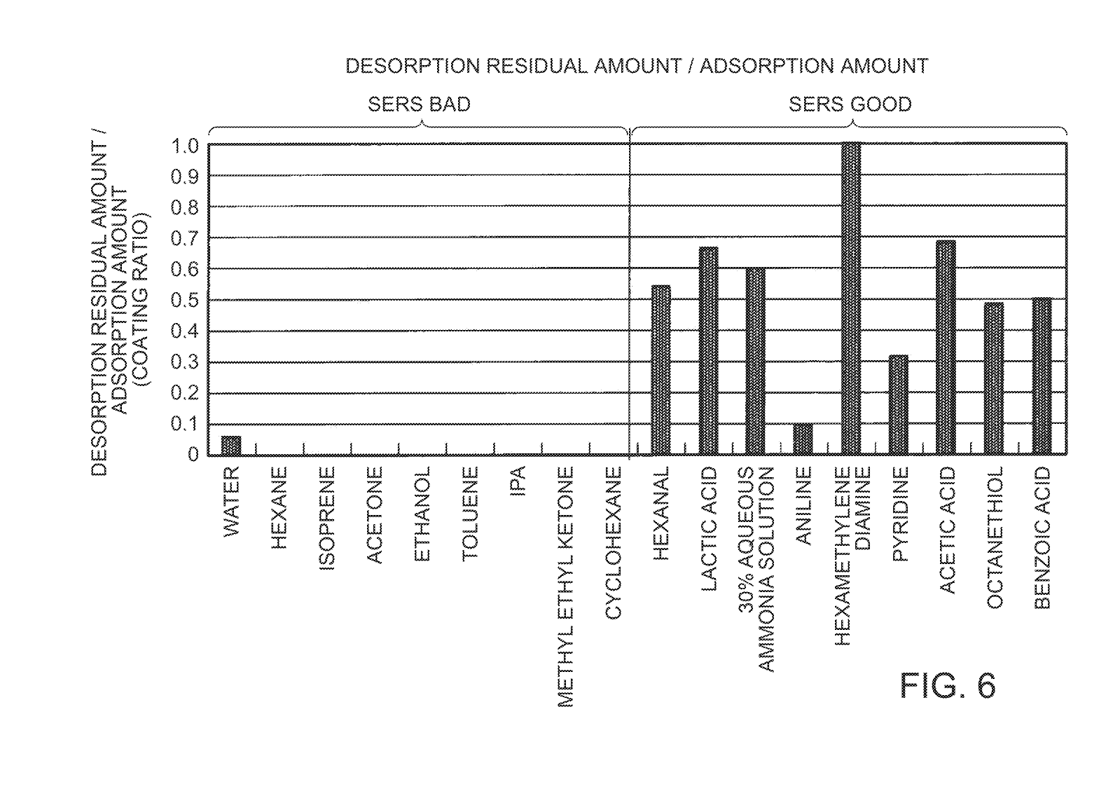

In order to make the bar graphs easy to understand, the ratio of the residual amount after switching to the exposure to air is shown in FIG. 6 by taking the value obtained by the exposure to the saturated vapor gas as 1. It is considered that most of the gases, for which the SERS signal was not detected, are immediately desorbed even if they are adsorbed on the surface (Au) of the quartz crystal resonator, and the gases, for which the SERS signal was detected, are adsorbed to some extent on the surface (Au) of the quartz crystal resonator.

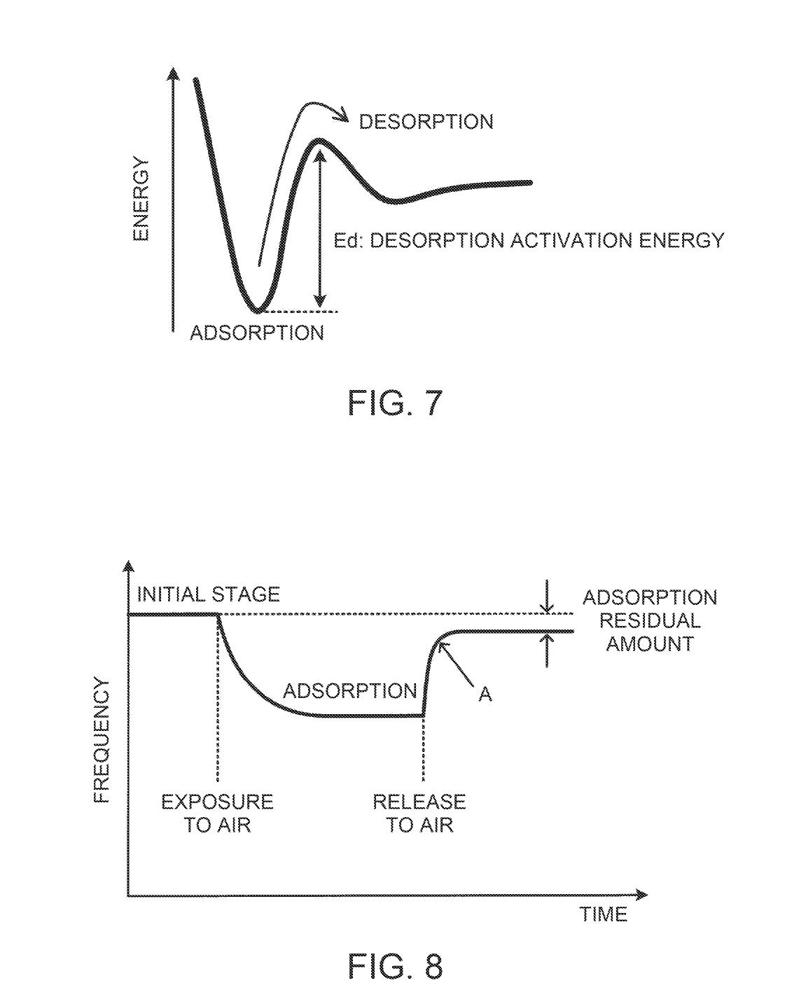

In order to understand this phenomenon, when the energy of a gas molecule on the surface of the quartz crystal resonator is considered, as shown in FIG. 7, when a gas molecule approaches the metal surface, there is an energy barrier. When crossing the barrier, the molecule enters a low energy state (an adsorbed state) and can be stabilized, however, if the desorption activation energy Ed is low, the gas molecule can cross the Ed with a thermal energy of around room temperature, and is desorbed.

Here, the desorption rate v(t) of the adsorbed gas is represented by the Polanyi-Wigner equation as follows.

$$v ( t ) = - C \frac{d θ ( t )}{d t} = {Cv}_{n} exp ( - \frac{{E}_{d}}{RT} ) \times {( θ ( t ) )}^{n} \qquad Math . 1$$

Here, v(t) represents a desorption rate, θ(t) represents a coating ratio, C represents the adsorption amount of gas, νn represents a frequency factor, n represents a reaction order, Ed represents a desorption activation energy, R represents a gas constant, and T represents an absolute temperature.

In the case where a molecule is adsorbed using one empty site, n=1, and therefore, when θ₀ represents the initial coating ratio, the coating ratio is represented as follows.

$$θ ( t ) = {θ}_{0} exp ( - At ) \\ A = {v}_{1} exp ( - \frac{{E}_{d}}{RT} ) \qquad Math . 2$$

Accordingly, the desorption residual amount σ(t) is represented as follows by integrating the desorption rate v(t).

$$σ ( t ) = \int v ( t ) d t = \int ( - C \frac{d θ ( t )}{d t} ) d t = C \times θ ( t ) \\ ∴ σ ( t ) = C {θ}_{0} exp ( - At ) \qquad Math . 3$$

Here, as shown in FIG. 8, the desorption activation energy Ed can be determined by measuring a change in mass of the molecule adsorbed on the surface of the QCM (quartz crystal resonator) as a change in frequency. That is, the desorption activation energy Ed can be determined as a change in frequency in the curve A region in FIG. 8.

On the other hand, in order to keep the gas molecule adsorbed on the metal surface, it is only necessary to make the desorption activation energy Ed higher than that of the metal nanostructures on which an enhanced electric field is formed. Therefore, it can be predicted that this can be realized by subjecting the metal nanostructures to a surface treatment. Moreover, the surface treatment is desired to be performed to such an extent that the gas molecule falls within the range of the enhanced electric field formed by the metal nanostructures. Even if a common resin material is dissolved in a solvent and applied by spin coating, the resulting film has a thickness of about several tens of nanometers, which falls outside the range where the enhanced electric field is strong, so that it is difficult to obtain a strong surface enhanced Raman effect.

Therefore, in the first embodiment, the desorption activation energy is increased by an organic molecular film, for example, a self-assembled monolayer (SAM film).

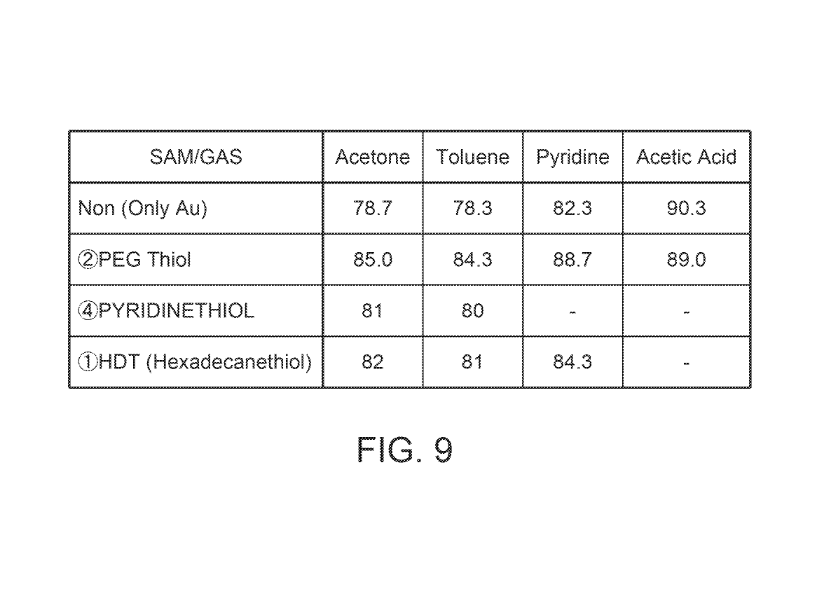

FIG. 9 shows the results of forming a SAM film on the quartz crystal resonator (Au electrode) and obtaining a desorption activation energy based on a change over time in desorption residual amount (adsorption amount). The unit of the numerical values in FIG. 9 is kJ/mol, and an average of three measurements per sample was adopted. Further, PEG in FIG. 9 denotes polyethylene glycol. As shown in FIG. 9, except for acetic acid, the desorption activation energy is increased when the SAM film is provided as compared with the case where the SAM film is not provided. Here, with respect to the molecular length of the SAM film, pyridinethiol has a relatively short molecular length, and PEG thiol and hexadecanethiol have a relatively long molecular length.

1.4. Principle of Enabling Detection Over Wide Range from Low Concentration to High Concentration

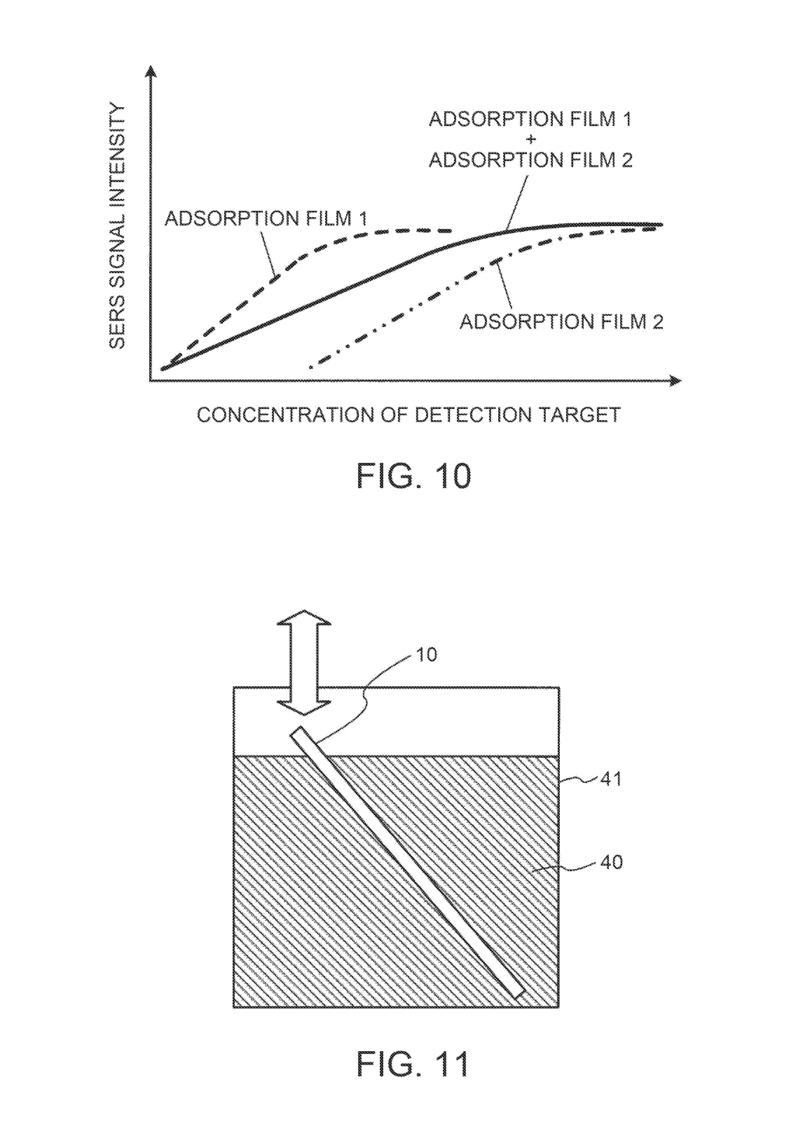

In the first embodiment, a fluid sample can be detected over a wide concentration range as shown in FIG. 10. This is realized by changing the types of the organic molecular films 18 and 19 to be formed in the enhanced electric fields with different intensities.

First, as described above, a strong enhanced electric field 13 is formed between the metal nanostructures 17 to create a hotspot. On the other hand, the enhanced electric field in a region facing the metal nanostructures 17 is not as strong as the enhanced electric field formed between the metal nanostructures 17.

Subsequently, by the first and second organic molecular films 18 and 19, a higher desorption activation energy than the desorption activation energy of only the metal nanostructures 17 is ensured, and therefore, the desorption of the measurement sample can be prevented. Accordingly, the detection signal level can be increased.

Further, the magnitude of the desorption activation energy ensured by the first and second organic molecular films 18 and 19 varies therebetween, and therefore, by selecting the first and second organic molecular films 18 and 19, the detection sensitivity over a concentration range from a low concentration to a high concentration can be appropriately adjusted.

The region between the metal nanostructures 17 where the first organic molecular film 18 is formed is a hotspot where the enhanced electric field is strong, and by improving the adsorbability of the measurement sample by the first organic molecular film 18, even if the concentration of the measurement sample is low, it can be detected with high sensitivity. Accordingly, as shown in FIG. 10, the intensity of the SERS signal based on a Raman scattered light in the region between the metal nanostructures 17 where the first organic molecular film 18 is formed changes in a low concentration range as the dashed line denoted by “adsorption film 1”.

On the other hand, in the region of the metal nanostructures 17 where the second organic molecular film 19 is formed, the enhanced electric field is relatively weak, however, if the adsorbability of the measurement sample is improved by the second organic molecular film 19, a signal level based on the detected light reflecting the measurement sample is ensured as long as the concentration of the measurement sample is high. Accordingly, as shown in FIG. 10, the intensity of the SERS signal based on a Raman scattered light in the region of the metal nanostructures 17 where the second organic molecular film 19 is formed changes in a high concentration range as the dashed line denoted by “adsorption film 2”.

In this manner, the concentration range of the measurement sample capable of being detected by one detection apparatus is expanded. Here, the SERS signal level based on a Raman scattered light in the region where the first organic molecular film. 18 is formed is saturated as shown by the dashed line denoted by “adsorption film 1” in FIG. 10. Therefore, the adjustment can be performed by selecting the first and second organic molecular films 18 and 19 such that the SERS signal level based on a Raman scattered light in the region where the second organic molecular film 19 is formed (the dashed line denoted by “adsorption film 2”) is detected from the concentration range in which the SERS signal level is saturated denoted by “adsorption film 1” shown in FIG. 10.

Here, a signal level obtained by adding the levels of the two dashed lines denoted by “adsorption film 1” and “adsorption film 2” in FIG. 10 is an output from a light detector. By the adjustment described above, the output from the light detector can be changed at a given angle of inclination as the solid line denoted by “adsorption film 1+adsorption film 2” in FIG. 10.

### 1.5. First and Second Organic Molecular Films

The second organic molecular film (second SAM film) 19 shown in FIG. 3 can be formed by a liquid phase method shown in FIG. 11. In FIG. 11, in a container 41 in which a SAM film material 40 in the liquid form is placed, the basic substrate 10 having the basic structure of the optical device 10 shown in FIG. 1 is dipped. A thiol group of the second SAM film 19 is easily adsorbed on the metal nanostructures 17, and moreover, the alkyl groups in the structures of the molecules act on one another to keep a certain degree of distance by the van der Waals force, and therefore, the second SAM film 19 is adsorbed on the metal nanostructures 17 as if it is arrayed.

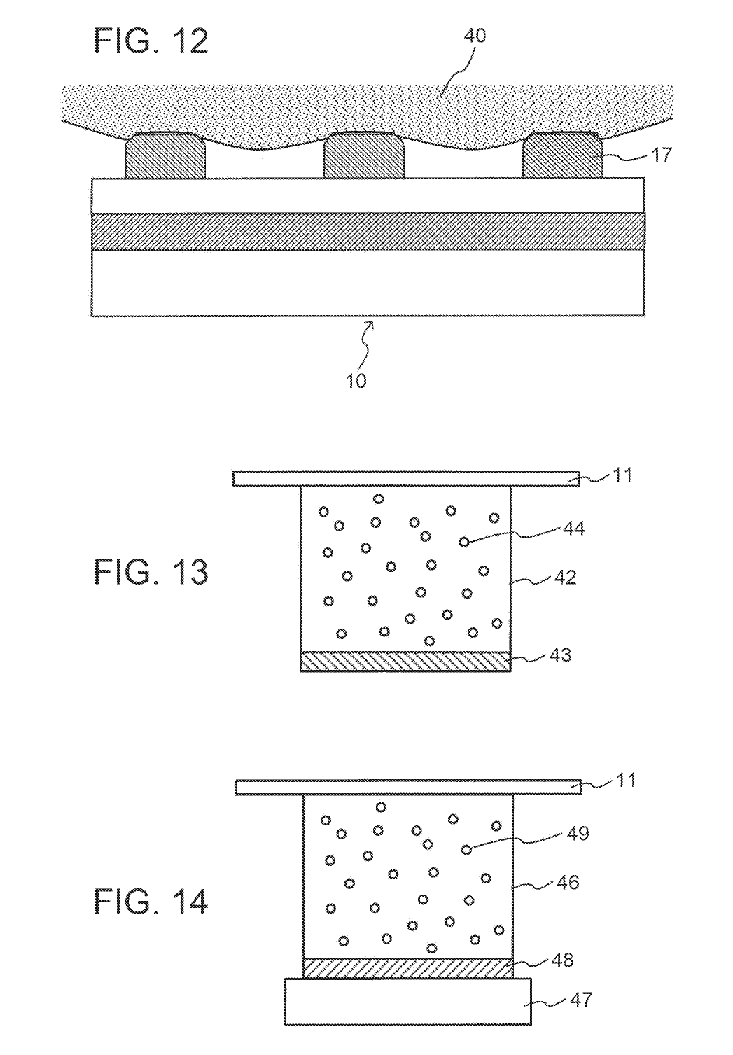

However, in the liquid phase method, as shown in FIG. 12, the SAM film material 40 in the liquid form does not penetrate into a space between the metal nanostructures 17 due to the surface tension. Therefore, the second SAM film 19 is formed only on the metal nanostructures 17. In this case, the type of SAM film having a molecular length suitable for the enhanced electric field in the vicinity of the surface is selected. On the metal nanostructures 17, the enhanced electric field by the enhancement structure is formed in a relatively wide range. Therefore, the second SAM film 19 having a relatively long molecular length suitable for the wide enhanced electric field was formed by the liquid phase method.

As the second SAM film 19, a SAM film having a molecular length suitable for the enhanced electric field such as 11-mercapto-1-undecanol, 11-mercaptoundecanoic acid, PEG3-OH alkanethiol or hydroxy-EG3-undecanethiol, thiol-dPEG4-acid, hexadecanethiol, propanethiol, 4-mercaptopyridine, thionicotinic acid, or a silane coupling agent is selected, but is not limited to those exemplified above. As the second SAM film 19 to be formed on the metal nanostructures 17, one having a thiol group (—SH), a disulfide group (—S—S—), or a carboxyl group (—COOH) is preferred. Other than these, as the second SAM film 19, a thiol reagent having an alkyl chain or a PEG chain, and also having a functional group such as OH or COOH at the end can be used.

Subsequently, by a gas phase method shown in FIG. 13 or 14, the first organic molecular film (first SAM film) 18 shown in FIG. 4 is formed. In the gas phase method, any SAM film material can be used as long as the material can evaporate or sublime, and the film can be formed also in a space between the metal nanostructures 17 shown in FIG. 12 where the material cannot penetrate by the liquid phase method. In FIG. 4, an example using thionicotinic acid as the first SAM film 18 is shown, however, the film is not limited thereto. In this manner, by combining the liquid phase method and the gas phase method, the optical device 12 shown in FIG. 4 can be completed through the intermediate substrate 11 shown in FIG. 3.

In the gas phase method shown in FIG. 13, a case where the material of the SAM film is a liquid is shown, and a small amount of a SAM film material 43 in the liquid form is placed in a container 42 and is evaporated, and a SAM film material 44 converted into a gas penetrates into a space between the metal nanostructures 17 in the intermediate substrate 11 placed on the opening of the container 42 and is adsorbed thereon. As shown in FIG. 14, in the case where a SAM film material 48 is a solid or a powder, the SAM film material 48 placed on the bottom of a container 46 is sublimed by heating with a heating device 47, whereby a SAM film material 49 converted into a gas penetrates into a space between the metal nanostructures 17 in the intermediate substrate 11 placed on the opening of the container 46 and is adsorbed thereon.

As the first SAM film 18 to be formed on the dielectric body 16 between the metal nanostructures 17, one having a silane coupling agent, a silanol group (—Si—OH), a titanium coupling agent, or a titanol group (—Ti—OH) is preferred.

Next, an example in which an SERS chip is produced by forming 11-mercapto-1-undecanol as the second SAM film 19 on the metal nanostructures 17 and thionicotinic acid serving as the first SAM film 18 between the metal nanostructures 17 will be described as another example.

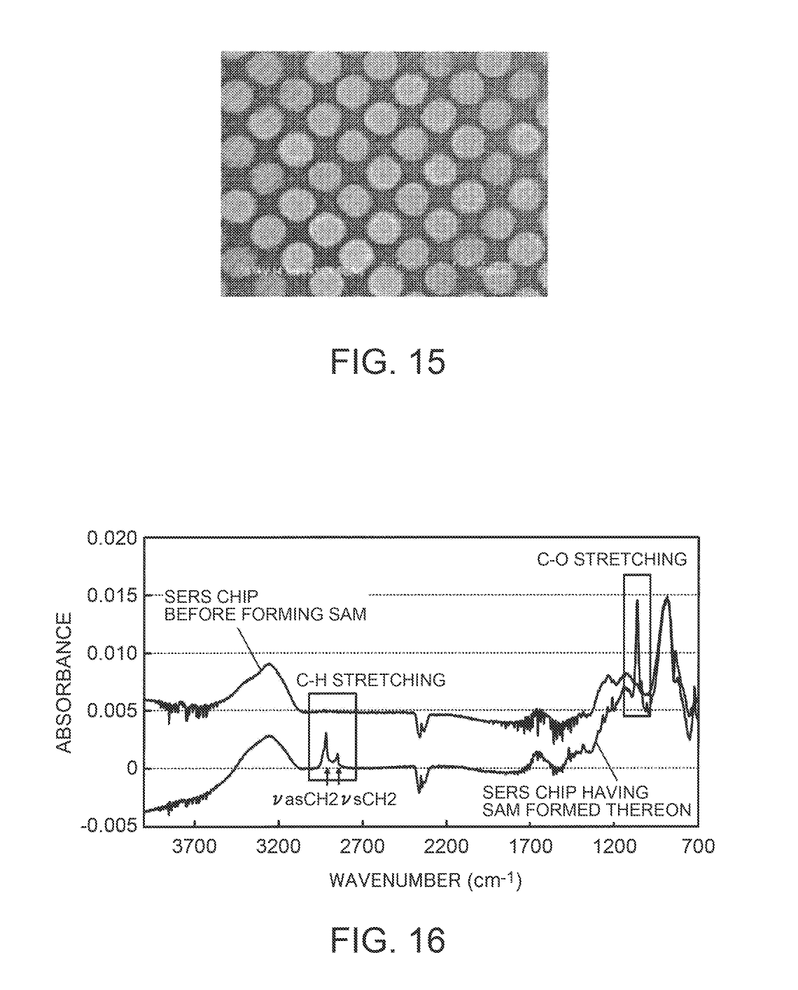

First, a 1 mM ethanol solution of 11-mercapto-1-undecanol (OH(CH₂)₁₁SH, Sigma-Aldrich, 447528-1G) was prepared, and a silver SERS chip was dipped overnight therein, whereby an alkanethiol film was formed on the surface of silver. As the silver SERS chip, as shown in FIG. 15, a chip obtained by forming Ag nanostructures having a particle diameter of 140 nm with a gap of about 10 nm between the constituent particles on the surface of a glass base plate was used.

Subsequently, a thionicotinic acid was formed as the first SAM film 18 by a gas phase method. In a glass container (6 mL), about 1 g of thionicotinic acid serving as the SAM forming material was placed, and the SERS chip in which the second SAM film 19 was formed was placed thereon so as to cover the container and left to stand for 2 hours at room temperature under air atmosphere.

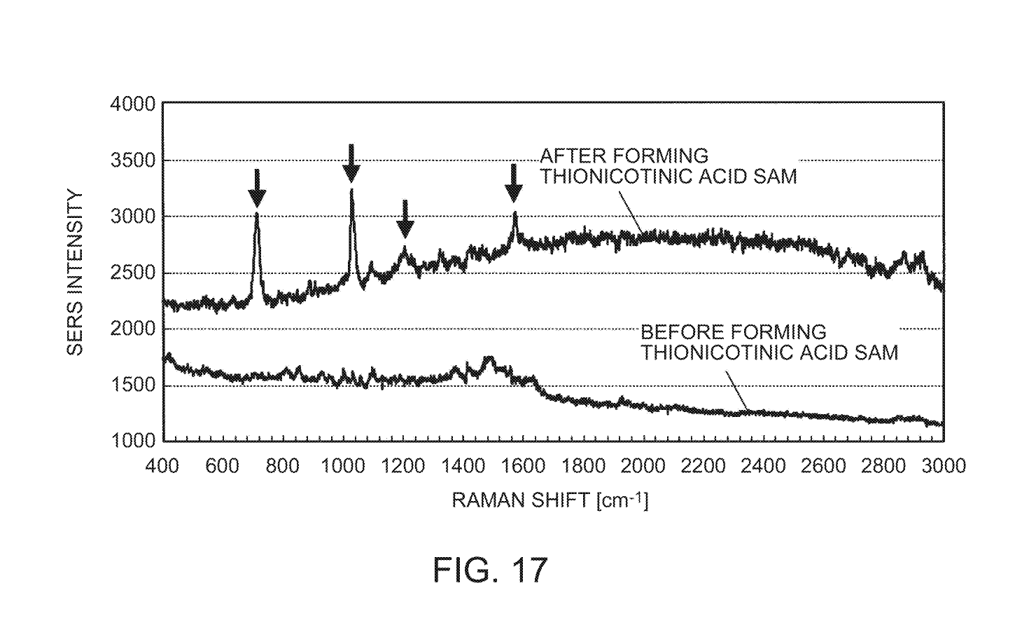

As the results of SERS measurement using the SERS chip before and after forming the first SAM film 18, the FT-IR spectrum is shown in FIG. 16, and the SERS signal intensity is shown in FIG. 17. In the case of SERS, since the electric field is particularly strongly enhanced in the region between the metal nanostructures 17 as described above, when a target molecule is present in this region, the information of this target molecule is obtained as a signal.

In FIG. 17, in the case of using the chip before forming the thionicotinic acid SAM serving as the first SAM film 18 (that is, only the 11-mercapto-1-undecanol SAM serving as the second SAM was formed), a signal derived from the SAM could not be observed. On the other hand, in the case of using the chip after forming the thionicotinic acid SAM, only signals derived from thionicotinic acid indicated by the arrows in FIG. 17 were observed. Based on these results, it is found that only the thionicotinic acid SAM was formed in the region between the metal nanostructures 17, and the 11-mercapto-1-undecanol SAM was formed only on the top of the metal nanostructures 17.

### 2. Second Embodiment

### 2.1. Overall Structure of Detection Apparatus

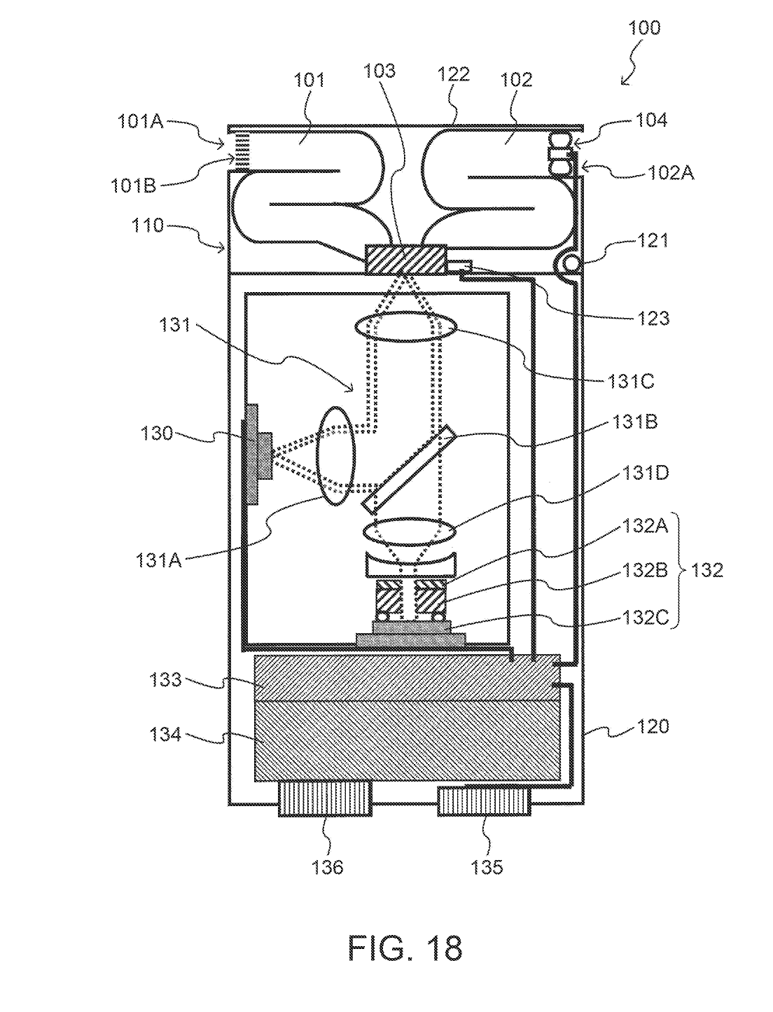

Next, the overall structure of a detection apparatus will be described as a second embodiment. FIG. 18 shows an example of a specific structure of a detection apparatus of this embodiment. A detection apparatus 100 shown in FIG. 18 includes a sample supply channel 101 having a suction port 101A and a dust removal filter 101B, a sample discharge channel 102 having a discharge port 102A, and an optical device unit 110 provided with an optical device (sensor chip) 103 having a structure shown in FIG. 4, and the like. On the optical device 103, a light is incident. A housing 120 of the detection apparatus 100 includes a sensor cover 122 which can be opened and closed by a hinge section 121. The optical device unit 110 is detachably mounted on the housing 120 in the sensor cover 122. The mounted/unmounted state of the optical device unit 110 can be detected by a sensor detector 123.

The sample supply channel 101 and the sample discharge channel 102 are each formed into a winding shape and therefore have a structure such that an outside light hardly enters.

Incidentally, a consideration is given to the shapes of the channels through which a fluid sample is sucked or discharged so that a light from outside does not enter the sensor and the fluid resistance to the fluid sample is decreased, respectively. By adopting a structure in which an outside light does not enter the optical device 103, a noise light other than a Raman scattered light does not enter, and thus the S/N ratio of a signal is improved. Also for the constituent material of the channel as well as the shape of the channel, it is necessary to select a material, a color, and a surface profile so that the light is hardly reflected. Further, by decreasing the fluid resistance to the fluid sample, a large amount of the fluid sample in the vicinity of this apparatus can be collected, and thus highly sensitive detection can be achieved. As the shape of the channel, by eliminating angular portions as much as possible and adopting a smooth shape, accumulation of the sample in an angular portion does not occur. It is also necessary to select a fan or a pump capable of producing a static pressure and an air flow rate appropriate to the channel resistance as a negative pressure generation section 104 provided in the fluid discharge channel 102.

In the housing 120, a light source 130, an optical system 131, a light detection section 132, a signal processing control section 133, and an electric power supply section 134 are provided.

In FIG. 18, the light source 130 is, for example, a laser, and from the viewpoint of reduction in size, it is preferred to use a vertical-cavity surface-emitting laser, but the light source is not limited thereto.

The light from the light source 130 is converted to a parallel light by a collimator lens 131A which constitutes the optical system 131. It is also possible to convert the parallel light to a linearly polarized light by providing a polarization control element downstream the collimator lens 131A. However, the polarization control element can be omitted if a light containing a linearly polarized light can be emitted by adopting, for example, a surface-emitting laser as the light source 130.

The light converted to the parallel light by the collimator lens 131A is guided toward the optical device 103 by a half mirror (dichroic mirror) 131B, and collected by an objective lens 131C, and then, incident on the optical device 103. A Rayleigh scattered light and a Raman scattered light from the optical device 103 pass through the objective lens 131C and are guided toward the light detection section 132 by the half mirror 131B.

The Rayleigh scattered light and the Raman scattered light from the optical device 103 are collected by a condenser lens 131D and input to the light detection section 132. In the light detection section 132, first, the lights arrive at a light filter 132A. By the light filter 132A (for example, a notch filter), the Raman scattered light is extracted. This Raman scattered light further passes through a spectroscope 132B and is then received by a light-receiving element 132C. The spectroscope 132B is formed from an etalon or the like utilizing, for example, Fabry-Perot resonance, and can make a pass wavelength band variable. The wavelength of the light passing through the spectroscope 132B can be controlled (selected) by the signal processing control section 133. By the light-receiving element 132C, a Raman spectrum specific to a sample molecule 1 is obtained, and by collating the obtained Raman spectrum with previously held data, the sample molecule 1 can be identified.

The electric power supply section 134 supplies electric power from a power supply connection section 135 to the light source 130, the light detection section 132, the signal processing control section 133, a fan 104, and the like. The electric power supply section 134 can be composed of, for example, a secondary battery, and may also be composed of a primary battery, an AC adapter, or the like. A communication connection section 136 is connected to the signal processing control section 133, and carries data, control signals, and the like to the signal processing control section 133.

In the example shown in FIG. 18, the signal processing control section 133 can send a command to the light detection section 132, the fan 104, and the like other than the light source 130 shown in FIG. 18. Further, the signal processing control section 133 can perform a spectroscopic analysis using the Raman spectrum, and the signal processing control section 133 can identify the sample molecule 1. Incidentally, the signal processing control section 133 can transmit the detection results obtained by the Raman scattered light, the spectroscopic analysis results obtained by the Raman spectrum, and the like to, for example, an external apparatus (not shown) connected to the communication connection section 136.

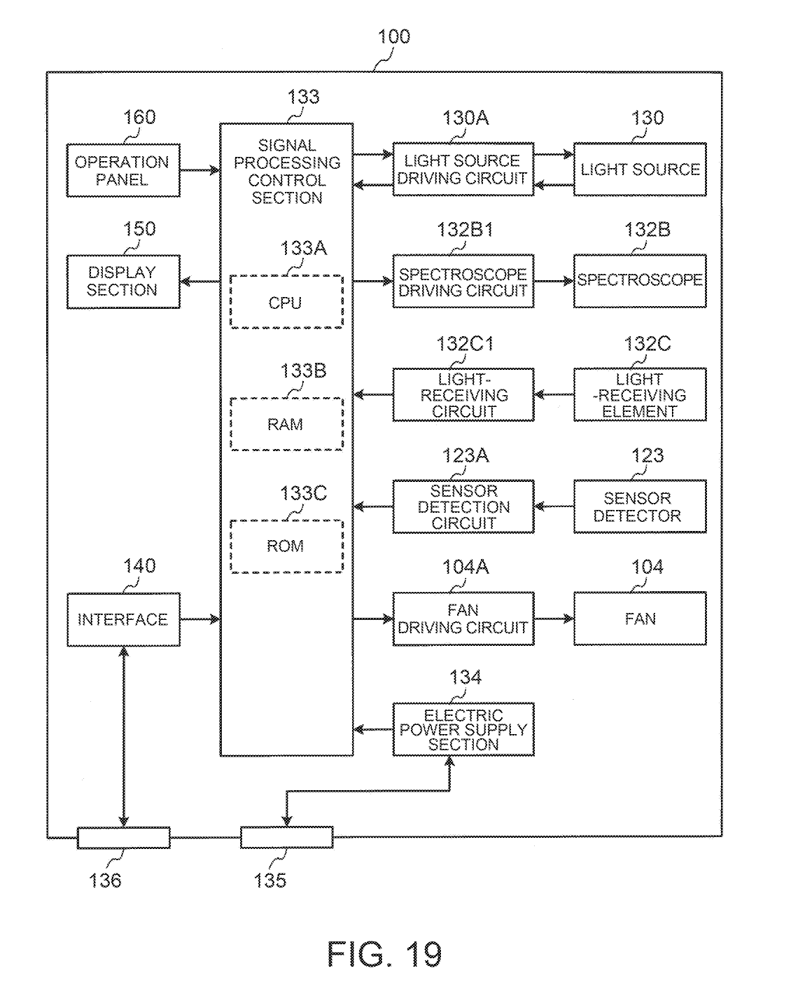

FIG. 19 is a block diagram of a control system of the detection apparatus 100 shown in FIG. 18. As shown in FIG. 19, the detection apparatus 100 can further include, for example, an interface 140, a display section 150, an operation panel 160, and the like. Further, the signal processing control section 133 shown in FIG. 19 can include a CPU (Central Processing Unit) 133A as the control section, a RAM (Random Access Memory) 133B, a ROM (Read Only Memory) 133C, and the like.

Further, the detection apparatus 100 can include alight source driving circuit 130A, a spectroscope driving circuit 132B1, a sensor detection circuit 123A, a light-receiving circuit 132C1, a fan driving circuit 104A, and the like, which drive the respective members shown in FIG. 18.

### 2.2. Light Source

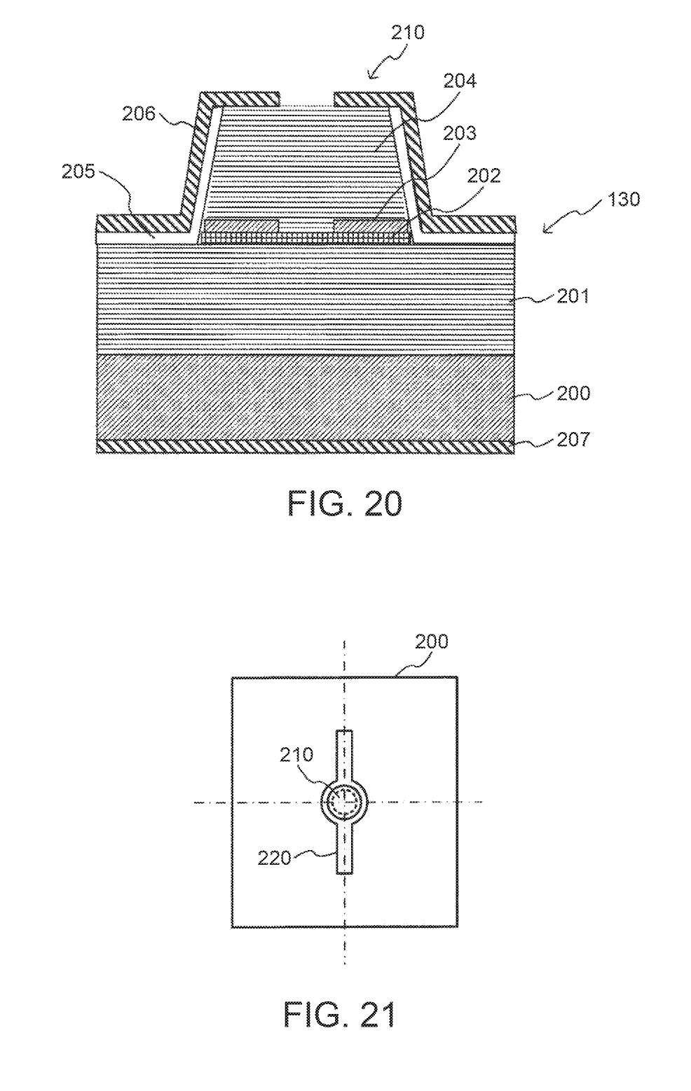

FIG. 20 shows an example of the structure of a vertical-cavity surface-emitting laser serving as the light source 130 shown in FIG. 18. In the example shown in FIG. 20, an n-type DBR (Diffracted Bragg Reflector) layer 201 is formed on an n-type GaAs substrate 200. An active layer 202 and an oxidation constriction layer 203 are provided in the center of the n-type DBR (Diffracted Bragg Reflector) layer 201. A p-type DBR layer 204 is provided on the oxidation constriction layer 203. An electrode 206 is formed around the periphery of these layers through an insulation layer 205. An electrode 207 is also formed on the rear side of the n-type GaAs substrate 200. In the example in FIG. 20, an active layer 202 is interposed between the n-type DBR layer 201 and the p-type DBR layer 204 so that a vertical resonator 210, in which a light generated from the active layer 202 resonates between the n-type DBR layer 201 and the p-type DBR layer 204, is formed. Incidentally, the vertical-cavity surface-emitting laser is not limited to the example shown in FIG. 20, and for example, the oxidation constriction layer 203 may be omitted.

The light source 130 shown in FIG. 18 is preferably a vertical-cavity surface-emitting laser (in a broad sense, a surface-emitting laser) capable of emitting a light in the direction perpendicular to the substrate surface (the optical axis of the light source) by resonating the light in the direction perpendicular to the substrate surface. By using the vertical-cavity surface-emitting laser, it is possible to configure a light source which is a monochromic (single wavelength) and linearly polarized light. In addition, the vertical-cavity surface-emitting laser can be reduced in size and is suitable for being incorporated into a portable detection apparatus. Further, in terms of the structure of the vertical-cavity surface-emitting laser, it is possible to form the resonator 210 without cleaving the substrate during the production process and inspect the characteristics of the laser, and therefore, it is suitable for mass production. Further, the vertical-cavity surface-emitting laser can be produced at relatively low cost as compared with other semiconductor lasers, and for example, a 2-dimensional array type vertical-cavity surface-emitting laser can also be provided. In addition, since the threshold current of the vertical-cavity surface-emitting laser is small, it is possible to reduce power consumption of the detection apparatus 100. Further, the fast modulation of the vertical-cavity surface-emitting laser can be achieved even at a low current, and the fluctuation width of the properties of the vertical-cavity surface-emitting laser with respect to change in temperature is small, and thus it is possible to simplify the temperature control section of the vertical-cavity surface-emitting laser.

Here, it was difficult to control the polarization plane of a laser light emitted from a conventional vertical-cavity surface-emitting laser to have a specific orientation, and there was a problem that fluctuation or switching of the polarization plane occurs depending on the light output or environmental temperature. In order to solve the problem, as disclosed in Japanese Patent No. 3482824, a distortion adding section 220 can be placed adjacent to the resonator 210 shown in FIG. 21. The distortion adding section 220 distorts the resonator 210 by applying anisotropic stress thereto, thereby causing birefringence or gain polarization dependence within the resonator. By providing the distortion adding section 220 around the periphery of the resonator 210, the polarization plane can be stably controlled.

While the embodiments have been described in detail in the above description, it could be easily understood by those skilled in the art that various modifications can be made without departing in substance from the novel matter and effects of the invention. Therefore, such modifications all fall within the scope of the invention. For example, in the specification or the drawings, a term which is described at least once together with a different term having a broader meaning or the same meaning can be replaced with the different term in any parts of the specification or the drawings. Further, the structures and operations of the optical device, the detection apparatus, the analysis apparatus, and so on are not limited to those described in the embodiments, and various modifications can be made.

In FIG. 22, for example, the smooth metal layer 15 shown in FIG. 1 is replaced with a metal layer 15A with periodic projections. This structure is a structure disclosed in Japanese Patent Application No. 2011-139526 applied by the present applicants as described above. The pitch of the projections of the metal layer 15A is, for example, 10 times or more larger than the arrangement pitch of the metal nanoparticles 17. If the metal film 15 has a lattice plane with periodic projections in this manner, when a light is incident on the periodic projections of the lattice, surface plasmons can be generated and propagating plasmons can be enhanced.

FIG. 23 shows an optical device in which the metal nanostructures 17 shown in FIG. 22 are formed as Ag metal islands on a SiO₂ layer (dielectric layer) 16 having a thickness of, for example, 40 nm. Incidentally, in FIG. 22, the surface of the dielectric body 16 is flattened, however, in FIG. 23, it is not flattened, and the surface of the dielectric body 16 reflects the projection pattern of the metal film 15 composed of, for example, Au. That is, the surface of the dielectric body 16 may be or may not be flattened. The size of the Ag particles shown in FIG. 23 varies within the range of 20 to 80 nm, and further, there is no periodicity.

The entire disclosure of Japanese Patent Application No. 2012-104462, filed May 1, 2012 is expressly incorporated by reference herein.

1. An optical device, which emits a light for detecting and/or identifying a measurement sample when an excitation light is incident thereon, wherein the optical device comprises:
multiple metal nanostructures formed on a dielectric body;
a first organic molecular film, which is formed on the dielectric body between two adjacent metal nanostructures among the multiple metal nanostructures; and
a second organic molecular film, which is different from the first organic molecular film and is formed on the multiple metal nanostructures, and
the first organic molecular film and the second organic molecular film attach the measurement sample.

2. The optical device according to claim 1, wherein
the first organic molecular film has a silane coupling agent, a silanol group (—Si—OH), a titanium coupling agent, or a titanol group (—Ti—OH).

3. The optical device according to claim 1, wherein
the second organic molecular film has a thiol group (—SH), a disulfide group (—S—S—), or a carboxyl group (—COOH).

4. The optical device according to claim 1, wherein
the molecular length of the first organic molecular film is shorter than that of the second organic molecular film.

5. A detection apparatus, comprising:
a light source;
the optical device according to claim 1, on which a light from the light source is made incident; and
a light detector which detects a light emitted from the optical device.
